(19) United States
(12) Patent Application Publication
(10) Pub. No.: US 2026/0328417 A1
(43) Pub. Date: Oct. 22, 2026

(54) ACTIVE THERMAL TRANSPORTATION SYSTEM

(71) Applicant: Ken LORENCE, Schaumburg, IL (US)

(72) Inventor: Ken LORENCE, Schaumburg, IL (US)

(21) Appl. No.: 19/100,436

(22) PCT Filed: Jul. 21, 2023
(86) PCT No.: PCT/US2023/028332

§ 371 Date: Jan. 31, 2025

Related U.S. Application Data
(63) Continuation of application No. 17/816,721, filed on Aug. 1, 2022, now abandoned.

(51) Int. Cl. F24F 5/00

(52) U.S. Cl. CPC F24F 5/0021; F24F 2221/17

(57) ABSTRACT

A system and method for temperature regulation in a refrigerated or heated container. A rail assembly including two opposing rails is attached to an inner surface of the container. A plurality of phase change material containers are connected between the rails. A vacuum insulation panel can further be placed between the phase change material containers and the inner surface of the container. The phase change material containers provide temperature regulation, and reduce operation of the heater or cooling system of the container, thereby reducing energy costs.

### FIELD OF INVENTION

The present invention relates to improvements in heated or refrigerated containers using phase change material (PCM) in specialized containers, and methods of manufacturing and use, and more particularly using PCM to increase the efficacy of heated or refrigerated shipping and/or storage containers using the PCM's temperature mitigating properties.

### BACKGROUND OF THE INVENTION

Phase change material (PCM), such as wax, fatty acids, and salt hydrates has existed for quite a while now, but the use of PCM in conditioned spaces for its air temperature regulating properties is a relatively recent development. Containers capable of holding PCM exist, but specialized containers for specific applications are needed and have yet to be developed. Just as there are many kinds of HVAC systems to heat or cool various types of facilities of all shapes and sizes, there will be many containers for PCM of all configurations and sizes for various applications depending on the particular needs of that space.

Presently, containers for PCM exist for the purpose of containing the PCM within a conditioned space. To name a few, the PCM filled blanket as well as the PCM filled panel are two of the most notable. The PCM blanket exists as a sheet of fluid filled pouches that resemble bubble wrap or oversized ketchup packages. The PCM panel exists as a hollow, desirably plastic container that resembles an ice pack used in lunch boxes. Though both the PCM blanket as well as the PCM panel have uses in various applications, for some applications neither are the best choice. For example, either the PCM blanket or the PCM panel are great in applications involving drop ceiling. The blanket can be placed above the ceiling tiles or the panel can replace the tiles themselves. However, neither of these containers are the best option for cold storage. For an application like cold storage, the container for the PCM needs to be able to mount or suspend from the ceiling in front of the evaporators.

Therefore, the need exists for improved PCM container designs that are applicable to specific installations providing the maximum benefit in those particular scenarios.

### SUMMARY OF THE INVENTION

The present invention is intended to provide an improved container mechanism and system for deploying PCM in conditioned spaces like, but not limited to, the refrigerated trailers of tractor-trailer rigs or storage cargo containers, walk-in refrigerators or freezers, or any sort of heated or cooled space. In order to maximize the temperature regulating effects of the PCM while also conserving usable space, the present invention is designed to fit securely on the inner ceiling or walls of the semi-trailer, refrigerator, freezer or conditioned space, thereby minimizing the cancellation of usable space, yet desirably positioned adjacent to the heating or cooling mechanism of the conditioned space. It is also contemplated that the present invention may be inserted into or otherwise integrated into the walls of the conditioned space to further maximize space as well as prevent damage to the containers holding the PCM. Furthermore, by creating this proximity of the present invention to the conditioned air moving off the heating or cooling mechanism of the air conditioning system, the effects of the PCM within the present invention are thereby enhanced as the PCM is charged by conditioned air at its coldest or warmest temperature. The PCM materials can further be implemented with other known insulation or cooling techniques, such as external roof heat deflection materials to further increase cooling efficiency.

The present invention can provide one or more advantages compared to existing PCM containers. The present invention places any suitable PCM, and preferably plant based and other PCM materials available from Phase Change Solutions, Inc. (e.g., BIOPCM® materials), within closest proximity to the heating and cooling mechanism of the conditioned space's air conditioning system, while also positioning the PCM on the inner ceiling and/or walls of the conditioned space where no precious storage or utility space is consumed. By situating the present in close proximity to the air conditioning mechanism, but also outside or on the fringe of usable space, the effects of the PCM are enhanced while not diminishing carrying or operating capacity of the trailer, fridge, freezer, or other conditioned space. For instance, an embodiment of the present invention made to mount on a semi trailer's roof or walls can maintain that refrigerated trailer at the desired temperature for longer periods of time without the use of active heating and cooling systems because of its proximity within the trailer to the conditioned air traveling through that trailer from the air conditioning system.

Additionally, the present invention is designed to offer bolt-on functionality thereby making installation as simple as attaching the rail assembly to the roof or walls of the conditioned space. Where the rail assembly and PCM container are part of a separable design, meaning the rail assembly and PCM container are not one cohesive part but two separate parts, the rail assembly simply adheres to the roof or walls of the conditioned space by bolts, screws, welds, or other attachment mechanisms and then the PCM container or containers slide into the rail assembly. Because conditioned spaces can vary in size, one embodiment of the present invention is designed to be comprised of components that attach to one another in a streamline fashion, thereby allowing the present invention to increase in length incrementally across the roof or walls of the conditioned space.

Furthermore, because of the present invention's enhanced surface area design, where the PCM containers within the rail assembly span the length and width of the trailer, the PCM within the present invention is able to interact with ambient air more effectively as the conditioned air flows across the present invention's surface. By designing the present invention in such a way that maximum surface area is obtained, the effects of the PCM are enhanced because more air interacts with more PCM.

Lastly, because of its interlinking design and ability to fasten to the roof of the trailer, the present invention is a more efficient alternative to other PCM containers like the panel or blanket, providing the same or more BTUs, while allowing quick installation, minimal consumption of usable space, and secure placement.

The invention includes a system for temperature regulation in a refrigerated or heated container. The system includes a rail assembly including two opposing rails, each configured to attach an inner surface of the container, and a plurality of phase change material containers configured to secure between the opposing rails. The rail assembly is desirably attached to a wall or ceiling of the container, such as a shipping/storage container. The rail assembly is desirably secured to the container with any suitable mechanical fastener or adhesive.

In embodiments, each of the rails comprises a C-shaped or L-shaped rail, wherein each of the plurality of phase change material containers slides between the rails from an end of the rail assembly. A removable end cap can be used to close the rails after the containers are added.

In embodiments of this invention, each of the plurality of phase change material containers includes a plastic, metal, or thick film/membrane housing enclosing a sealed hollow inner chamber including a phase change material. In preferred embodiments, each of the plurality of phase change material containers is cuboidal in shape, such as to maximize coverage between the rails. Each of the plurality of phase change material containers can include air passageways or perforations extending through the phase change material containers between opposing surfaces, such as to increase surface area.

In embodiments of this invention, an insulation layer is disposed between the plurality of phase change material containers and a surface of the refrigerated or heated container. Both the plurality of phase change material containers and the insulation layer desirably slide into the rail assembly from ends of the opposing rails. The rail dimensions can be adjusted for two layers. The insulation layer desirably includes a vacuum insulated panel, such as a microporous insulation core sealed under vacuum by an outer material, such as a film.

The invention further includes methods of reducing energy use in heating or cooling a container by installing a rail assembly within a container and sliding the plurality of phase change material containers, with or without the insulation layers, between the rails. The method further includes operating a heating or cooling system within the container. The heating or cooling system can be operated as normal, but the PCM containers will desirably reduce operation time and energy use. Thus the use of the system of this invention reduces energy use in heating or cooling the container.

### DESCRIPTION OF THE DRAWINGS

FIG. 1 is a perspective view of a system according to one embodiment of this invention, by which the rail assembly is represented by two individual rails situated adjacent to the PCM containers with the PCM containers existing between the two rails; a PCM container is represented by cuboidal figures with circular holes; and the attachment mechanism is represented by the perforations within the rails.

FIG. 2 is a partial side view of an end of a rail assembly according to one embodiment of this invention.

FIG. 3 is a perspective view of a system according to one embodiment of this invention, illustrating most of the same aspects as detailed in FIG. 1, but highlighting the ability of the rail assembly and PCM containers of FIG. 1 to be arranged into a series of rail assembly and PCM containers situated side by side.

FIG. 4 is a perspective view of a system according to one embodiment of this invention illustrating the placement of the system on the ceiling of a conditioned space, whereby the system is within the airflow flyway of the air conditioning system but not consuming space needed to store the cargo.

FIG. 5 is a side or end view of a system according to one embodiment of this invention.

FIG. 6 is a perspective view of a system according to one embodiment of this invention, where the PCM container is permanently attached to rails.

### DETAILED DESCRIPTION OF THE INVENTION

Implementations described herein can be understood more readily by reference to the following detailed descriptions, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of this disclosure.

The invention includes a system, herein referred to as an active thermal transportation system or ATTS. The ATTS described herein desirably includes a single unit or series of rail assemblies that mount to the roof or walls of refrigerated spaces where the rail assemblies are secured in such a way to hold specially designed PCM filled containers, which may be permanently affixed to the rail assembly or removable from the rail assembly. The ATTS design allows for maximum surface area to volume ratio of the PCM filled containers leading to increased efficacy of the PCM.

The ATTS consists of a rail assembly that mounts to the roof (i.e., inner ceiling) of a refrigerated space by use of various attachment mechanisms such as, but not limited to, bolts, screws, glue, welds, or any other attachment mechanism able to hold the weight of the ATTS. The rail assembly consists of two rails of fixed length designed to exist at a fixed distance apart from one another for the purpose of holding PCM filled containers securely to the roof or walls of the conditioned space. The rails within the rail assembly can be made of any material able to hold the weight and shape of the PCM containers. The PCM containers, designed to fit securely into the rail assembly, may assume a variety of shapes such as, but not limited to, a flattened cuboidal shape with a “Swiss cheese” like internal structure that creates a fixed structure for holding the PCM while encompassing a shape that maximizes the surface area to volume ratio of the container. It is also contemplated that the PCM container may take the shape of a honeycomb, or a coil, or be dimpled, or assume the arrangement of fins within a radiator. The ATTS may be comprised of a multi-component system where the PCM containers are separable from the rail assembly having the capability of being removed and reinserted into the rail assembly, or a single-component system where the PCM containers are permanently fixed to the rail assembly and the unit as a whole mounts to the roof or wall of the conditioned space as a complete product.

Exemplary embodiments of such ATTS will now be more fully described with reference to the figures.

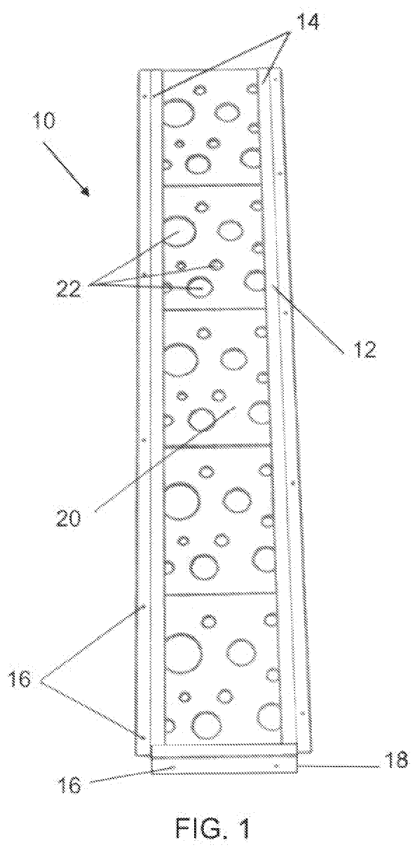

FIG. 1 illustrates a perspective view of a system (e.g., ATTS) 10 according to one embodiment of this invention. The system 10 includes a rail assembly 12 including two opposing individual rails 14. The rail assembly 12 attaches to an inner surface of a heated or cooled space by any suitable attachment mechanism, for example, a sheet metal screw or bolt through a fastener opening 16. The opposing rails support therebetween a plurality of PCM containers 20. Each of the PCM containers 20 includes air through-openings or passages 22 which can be used to increase surface area of the containers 20.

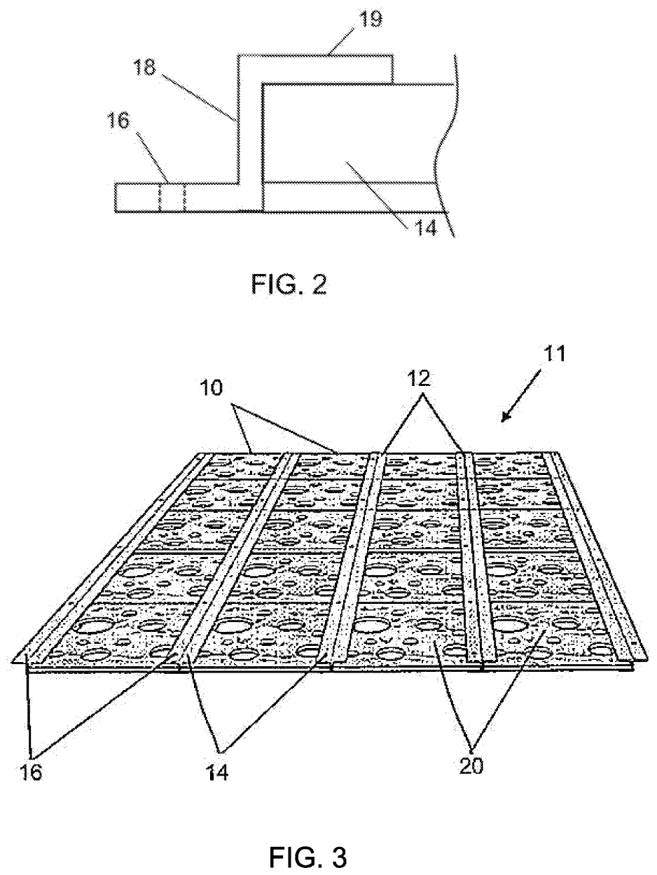

As shown in FIG. 1, the PCM containers 20 desirably slide between the rails 14, and the rails 14 have a length that is desirably a multiple of at least 2 times, and more desirably between 3-6 times, the length of the containers, thereby allowing two or more containers to fit with the rail assembly 12. Different size rails can be used in an installation, such as where both longer and shorter rails are needed to build around existing heating/cooling system components (e.g., compressors, heat exchangers, fans, ductwork, etc.). The end of the rails 14, on one or both ends, can be covered by an end cap 18. FIG. 2 shows a side view of an exemplary end cap 18, where an upper flange 19 extends over the ends of the rails 14. The end cap can also be made without the overlapping flange 19, and simply abutting the open end of the rails 14.

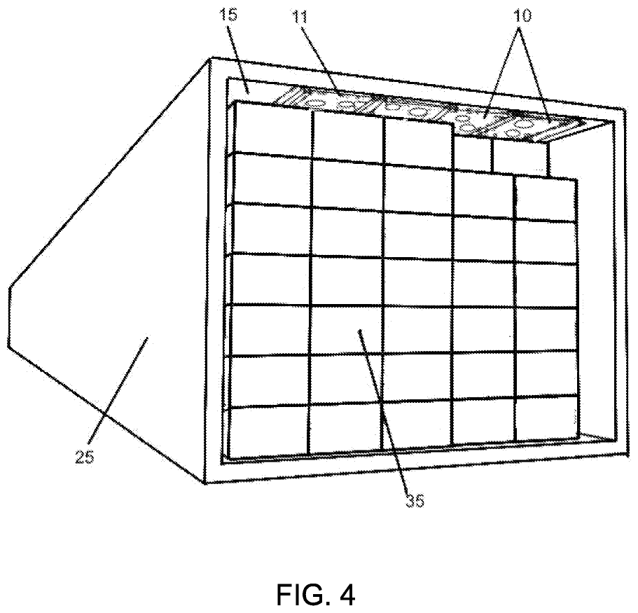

FIG. 3 illustrates a perspective view of an installation 11 of multiple ATTS assemblies 10 combined to cover an inner surface of a container, such as shown on a ceiling 15 in FIG. 4. The PCM container system 10 includes multiple rail assemblies 12, multiple individual rails 14, multiple rows of PCM containers 20, and the attachment mechanisms 16. FIG. 4 illustrates a perspective view of one type of conditioned space 25 holding cargo 35 that is installed with PCM containers 20 using the container system of four ATTSs 10 mounted on the ceiling 15 of the conditioned space 25. The use of the installation in the refrigerated space has been unexpectedly discovered to significantly reduce the running time of the cooling system while maintaining the desired temperature, thereby reducing energy/fuel costs.

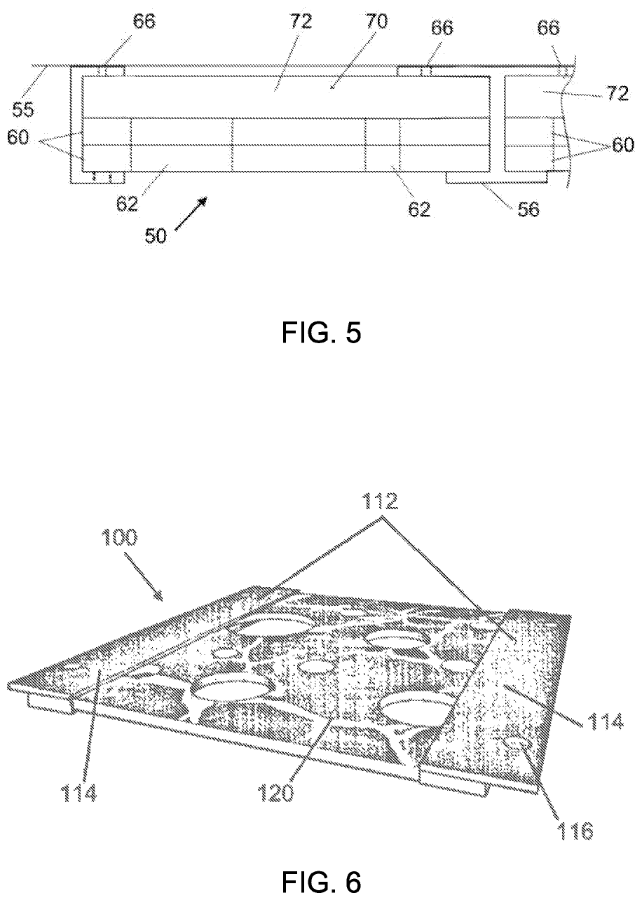

FIG. 5 is a side view of a system 50 according to one embodiment of this invention. The system 50 includes two opposing rails 54 and 56, each with a C-shaped opening to receive the PCM containers 60. As shown, I-shaped rail 56 can be used between adjacent rows of PCM containers 60 instead of two back-to-back C-shaped rails. The rails 54 and 56 are attached to a container inner surface 55, such as by bolts through coupling openings 66. The attachment flanges can be extended as shown in the I-shaped rail 56, for improved attachment tool access. Alternatively the lower flange can include an opening as shown in the C-shaped rail 54 to allow tool bit access to the fastener. The PCM 60 is again shown with passageways 62 extending between opposing surfaces of the PCM containers 60.

The embodiment of FIG. 5 further includes an optional double stack of PCM containers 60. Including stacked PCM containers 60 can allow flexibility in adjusting and providing the desired efficiency (e.g., the desired Btu value/rating).

The embodiment of FIG. 5 further includes an insulation layer 70, such as formed of insulation panels 72. The insulation panels 70 are preferably matched in size to one or more of the PCM containers 60. The rails 54 and 56 are sized larger to accept both PCM containers 60 and insulation panels 70. The insulation panels 70 add additional insultation between the storage/transport container surface 55 and the PCM container 60. Any suitable insulation material can be used, such as fiberglass, mineral wool, polystyrene, etc. In preferred embodiments, the insulation panels 70 are vacuum insulated panels. Presently preferred vacuum insulated panels include an insulation core, such as a foam or a microporous material, sealed under vacuum by an outer material, such as a film. The core can be formed of a polymer material or a blend of pyrogenic silica with a fiber reinforcement. The core is desirably encapsulated in an ultra-low permeable barrier film that includes multiple metalized polymer layers sealed under vacuum. The insulation panels can be rigid, similar to the PCM containers, or flexible like an insulation blanket.

Various sizes, shapes, and configurations are available for the rails, PCM containers, and insulation layers of this invention. For example, FIG. 6 illustrates another embodiment of an ATTS 100 where the PCM container 120 is permanently attached in the rail assembly 112 between the opposing rails 114. The rails have fastener openings 116. As another alternative, the PCM containers can be made with fastener through holes. However, the rail assembly generally provides a more secure attachment structure, while allowing for easy PCM container replacement if damaged due to moving cargo within/from the container.

The attachment mechanisms of this invention, by which the ATTS is secured to the ceiling or wall of a heated or refrigerated space, can be any suitable connector. The attachment mechanism can have various shapes and contemplates various connection methods from bolt on, to screw on, to glue on, to weld on, etc. The attachment mechanism is connected to or is a part of the rail assembly. The rail assembly is a frame-like structure consisting of two or more individual rails. In one embodiment, the rail assembly doubles as the frame or support for the general structure of the ATTS as well as the component of the ATTS which holds the PCM containers. In embodiments of this invention, the attachment mechanism include two-piece pin and collar fasteners, such as Huck fasteners.

An individual rail according to embodiments of this invention is an elongated C-shaped, I-shaped, or L-shaped structure made of a rigid material such as, but not limited to, metal, plastic, etc. Depending on the needs of a given conditioned space, an end cap can be added to the ends of the rail assembly to secure the PCM container within the rail assembly. One embodiment of the PCM container is a “Swiss cheese” shaped rectangular cuboid which has a hollow center and open cavities or air passages. As illustrated by the PCM containers 20 depicted in FIGS. 1 and 3, an individual PCM container 20 embodies a radiator-like design where it has the capability to hold a fluid like the PCM, but also allow air to pass through its cavities or air passages 22. It is contemplated that the PCM container 20 may embody varying shapes and dimensions with varying shapes and styles of air passages, such as containers that look like finned radiators or honeycomb containers. The air passageways can also extend longitudinally from end to end through the containers. The containers can also be formed with no air passages, or with surface structuring such as undulations, dimpling, or fins.

Thus the invention provides a PCM or PCM/insulating system that improves heating or cooling efficiency of a space. The PCM absorbs and releases energy, thereby resulting in less heating or cooling operation by the space's machinery. The individual panels allow for easy installation, and for replacement if any panel is damaged, such as by forklift loading/unloading of the container trailer.

The invention illustratively disclosed herein suitably may be practiced in the absence of any element, part, step, component, or ingredient which is not specifically disclosed herein. The various components of the different embodiments can further be exchanged with one another, depending on need.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A system for temperature regulation in a refrigerated or heated container, the system comprising:
a rail assembly including two opposing rails, each configured to attach an inner surface of the container; and
a plurality of phase change material containers configured to secure between the opposing rails.

2. The system of claim 1, wherein each of the rails comprises a C-shaped or L-shaped rail opening configured to receive the plurality of phase change material containers, wherein each of the plurality of phase change material containers slides within the rail openings and between the rails from an end of the rail assembly.

3. The system of claim 1, wherein the rail assembly is attached to a wall or ceiling of the container.

4. The system of claim 1, wherein each of the plurality of phase change material containers comprises a sealed hollow inner chamber including a phase change material.

5. The system of claim 4, wherein each of the plurality of phase change material containers include air passageways or perforations extending through the phase change material containers between opposing surfaces.

6. The system of claim 5, wherein each of the plurality of phase change material containers comprises a sealed hollow inner chamber including a phase change material.

7. The system of claim 6, wherein each of the plurality of phase change material containers is cuboidal in shape.

8. The system of claim 6, wherein each of the plurality of phase change material containers include air passageways or perforations extending through the phase change material containers between opposing surfaces.

9. The system of any of claim 8, wherein the rail assembly is secured to the container with a mechanical fastener.

10. The system of claim 9, further comprising a removable end cap extending between ends of the opposing rails

11. The system of claim 1, further comprising an insulation layer disposed between each of the plurality of phase change material containers and a surface of the refrigerated or heated container.

12. The system of claim 11, wherein each of the plurality of phase change material containers and the insulation layer slides into the rail assembly from an end of the opposing rails.

13. The system of claim 11, wherein the insulation layer comprises a vacuum insulated panel.

14. The system of claim 13, wherein the insulation layer comprises a microporous insulation core sealed under vacuum by an outer material.

15. The system of claim 14, wherein the outer material is a film.

16. The system of claim 10, further comprising an insulation layer disposed between each of the plurality of phase change material containers and a surface of the refrigerated or heated container.

17. The system of claim 16, wherein each of the plurality of phase change material containers and the insulation layer slides into the rail assembly from an end of the opposing rails.

18. The system of claim 16 or 17, wherein the insulation layer comprises a vacuum insulated panel including a microporous insulation core sealed under vacuum by an outer film material.

19. (canceled)

20. (canceled)

21. A method of reducing energy use in heating or cooling a refrigerated or heated container, the method comprising:
installing the rail assembly of claim 1 within the container; and
sliding the plurality of phase change material containers into the rail assembly.

22. The method of claim 21, further comprising:
sliding an insulation layer into the rail assembly between the phase change material containers and the inner surface of the refrigerated or heated container; and
operating a heating or cooling system for the refrigerated or heated container.

23-25. (canceled)
